(19) United States
(12) Patent Application Publication
(10) Pub. No.: US 2018/0209417 A1
(43) Pub. Date: Jul. 26, 2018

(54) ROTARY PISTON PUMP COMPRISING RADIAL BEARINGS ON ONLY ONE HOUSING PART

(71) Applicant: Robert Bosch GmbH, Stuttgart (DE)

(72) Inventors: Jochen Aleker, Stuttgart (DE); Jaochim Boltz, Schwieberdingen (DE); Klaus Sassen, Marbach/N (DE)

(21) Appl. No.: 15/745,270

(22) PCT Filed: Jun. 9, 2016
(86) PCT No.: PCT/EP2016/063099

§ 371 Date: Jan. 16, 2018

(30) Foreign Application Priority Data
Jul. 16, 2015 (DE) 10 2015 213 387.7

(51) Int. Cl. F04C 2/10; F02M 59/12; F04C 15/00

(52) U.S. Cl. CPC F04C 2/102; F02M 59/12; F04C 15/008; F04C 14/18; F04C 2240/30; F04C 2240/40; F04C 2240/51

(57) ABSTRACT

The invention relates to a rotary piston pump (16) for conveying a fluid, comprising at least two rotors (52) with conveyor elements (53), a rotational movement being implementable thereby about an rotational axis (61), a working chamber on the at least two rotors (52), a multi-part housing (42) with a first housing part (44) and a second housing part (43), at least two radial bearing shapes (37, 38) being designed on the housing (42) to act as a radial sliding bearing for the at least two rotors (52), and the at least two radial bearing shapes (37, 38) being designed on only one of said housing parts (44).

### BACKGROUND OF THE INVENTION

The present invention relates to a rotary piston pump and to a high pressure injection system.

Rotary piston pumps with an electric motor are used for a very wide variety of technical applications for conveying a fluid. For example, pre-feed pumps serve as fuel pumps for conveying fuel to a high pressure pump.

In high pressure injection systems, gerotor pumps with an internal gearwheel and an external gearwheel mounted eccentrically with respect thereto are also used as pre-feed pumps. The gerotor pumps here have an inflow channel which opens in an inflow working space in order to introduce the fluid to be conveyed into the inflow working space, and an outflow channel which opens into an outflow working space in order to drain the fluid to be conveyed from the outflow working space. The inflow working space therefore constitutes an intake side of a working space of the gerotor pump and the outflow working space constitutes a delivery side of the working space.

A working space of the gerotor pumps, which comprises the inflow working space and the outflow working space, is bounded by a housing. Within the working space, the internal gearwheel and the external gearwheel are mounted on the housing by means of a plain bearing. The internal and external gearwheel are slidingly mounted radially on different housing parts by radial bearing geometries.

During the production of the gerotor pump, said different housing parts are connected to each other. The axis of rotation of the internal gearwheel is at a distance from the axis of rotation of the external gearwheel, that is to say the internal gearwheel and the external gearwheel are mounted eccentrically with respect to each other. Owing to the design of the radial bearing geometries for the internal and external gearwheel on different housing parts, manufacturing inaccuracies cause an increased tolerance limit, and therefore large tolerances occur as a result between the internal and external gearwheel. Said inaccuracies bring about increased mechanical wear and lower hydraulic efficiency of the gerotor pump in a disadvantageous manner.

DE 36 24 532 C2 discloses a vane pump or internal-axis gear pump with a plurality of closed conveying cells, the volume of which changes from a minimum value to a maximum value and back during one revolution. The pump is used in particular for conveying fuel to an internal combustion engine. With intake and delivery channels entering the conveying cells axially and the opening cross sections of which are designed for conveying without internal compression, such compression is achieved, however, by stationary thrust washers which are placed against axial surfaces of the pump parts and form nonreturn valves.

DE 34 06 349 A1 discloses a positive displacement machine with at least two gear machines, to which a specific or a common hydraulic circuit is assigned, and the common conveying flow of which is variable by a control means, wherein the control means is arranged in a housing part of the positive displacement machine.

DE 299 13 367 U1 presents an internal gear pump with at least one internally toothed internal geared wheel and an externally toothed impeller which meshes with the latter, with or without a sickle, and with an electric drive which is formed by the internal geared wheel being the interior of a rotor of a brushless electric motor and a stator being arranged adjacent to the rotor, wherein the rotor containing the internal geared wheel is held rotatably on the outer side by a bearing or a plain bearing, wherein the stator is shielded and sealed in relation to the rotor and in relation to the interior of the pump by the bearing or plain bearing which is located between stator and rotor being impermeable to liquid and being tightly connected to a respective closure cover at its two end sides.

### SUMMARY OF THE INVENTION

A rotary piston pump according to the invention for conveying a fluid, comprising at least two impellers with conveying elements by which a rotational movement about a respective axis of rotation can be carried out, a working space present at the at least two impellers, a multipart housing with a first housing part and a second housing part, wherein at least two radial bearing geometries for the radial plain bearing of the at least two impellers are formed on the housing, wherein the at least two radial bearing geometries are formed on only one housing part. The at least two radial bearing geometries for the at least two impellers are formed in an advantageous manner on only one housing part. As a result, the axes of rotation of the at least two impellers are oriented with high accuracy with respect to each other since the two radial bearing geometries determine the radial orientation of the two impellers and therefore also the axes of rotation of the at least two impellers. As a result, an accumulation of manufacturing inaccuracies because of the at least two radial bearing geometries being formed on different housing parts does not occur.

In an additional embodiment, all of the radial bearing geometries for all of the impellers are formed on only one housing part, in particular all of the radial bearing geometries are formed on only one side of the only one housing part, and/or the working space is divided into an inflow working space and into an outflow working space. When the radial bearing geometries are formed on only one side of the housing part, the housing parts can first of all be fastened or clamped in a machining machine, for example a milling and/or drilling machine, for processing by cutting and subsequently, with said only single clamping operation, the housing part can be produced from an unprocessed component by cutting, for example by means of milling and/or drilling, and therefore the radial bearing geometries are thereby aligned with one another particularly accurately with a high degree of manufacturing accuracy. The axes of rotation of the at least two impellers of the rotary piston pump are thereby also aligned with respect to one another with a particularly high degree of accuracy.

In an additional embodiment, a centering geometry for the radial centering of another housing part is formed on the housing part with the at least two radial bearing geometries, in particular all of the radial bearing geometries and the centering geometry are formed on only one side of the housing part. By means of the formation of the centering geometry for the other housing part on the housing part with the at least two radial bearing geometries, the other housing part is also aligned with the impellers with a particularly high degree of accuracy.

In an additional refinement, the at least two impellers, in particular all of the impellers, are mounted in the axial direction in a first axial direction on the first housing part and are mounted in the axial direction in a second axial direction on the second housing part.

Expediently, the rotary piston pump comprises an inflow channel opening into the inflow working space for introducing the fluid to be conveyed into the inflow working space and an outflow channel opening into the outflow working space for draining the fluid to be conveyed from the outflow working space.

In an additional variant, the inflow channel and/or the outflow channel are/is formed on the housing part with the at least two radial bearing geometries, in particular all of the radial bearing geometries. Consequently, an inflow channel and/or outflow channel is generally not required on the second housing part, and therefore, as a result, the second housing part is formed particularly simply with a low mass without the radial bearing geometries and without the inflow channel and/or without the outflow channel.

In an additional embodiment, a first radial bearing geometry is designed as a bearing stub, and the bearing stub is arranged within a bearing bore of a first impeller, or vice-versa, such that the first impeller is mounted radially by means of the bearing stub.

In an additional refinement, a second radial bearing geometry is designed as a bearing step which is at least partially, in particular completely, of annular design, and the bearing step rests on a complementarily designed bearing recess of a second impeller, or vice-versa, such that the second impeller is mounted radially by means of the bearing step. The first and/or second radial bearing geometry can have any geometry or shape, for example can also be designed as a ring which is arranged in a complementary annular groove on the at least one impeller.

Expediently, the conveying elements are teeth of a gearwheel, and/or the rotary piston pump is a gear pump, preferably an internal gear pump, in particular a gerotor pump.

In an additional embodiment, the rotary piston pump comprises an electric motor and the electric motor is integrated in the rotary piston pump, in particular the gear pump, in particular by a rotor of the electric motor forming an impeller, preferably by permanent magnets being fitted into the impeller, and/or the capacity of the rotary piston pump can be controlled and/or regulated, preferably with the integrated electric motor, in particular by the power and/or rotational speed of the electric motor being able to be controlled and/or regulated.

In a further variant, the internal gear pump comprises an internal gearwheel with the bearing bore as the first impeller, and an external gearwheel with the bearing recess as the second impeller.

In an additional refinement, the housing part with the at least two radial bearing geometries, in particular all of the radial bearing geometries, as the first housing part is of substantially plate-like design.

Preferably, the housing part without the at least two radial bearing geometries, in particular without all of the radial bearing geometries, as the second housing part is of substantially pot-shaped design.

In an additional variant, the at least two housing parts, in particular all of the housing parts, and/or the at least two impellers, in particular all of the impellers, are formed from the same material, in particular steel or aluminum, and/or the second housing part is connected to the first housing part, preferably releasably, to each other with at least one fastening element, in particular a screw or rivet connection, and/or a seal, in particular an O-ring seal, for the fluidtight sealing of the working space is arranged between the first and second housing part.

A high pressure injection system according to the invention for an internal combustion engine, comprising a high pressure pump, a high pressure rail, a pre-feed pump for conveying a fuel from a fuel tank through a fuel line to the high pressure pump, wherein the pre-feed pump is designed as a high pressure pump described in this patent application.

Preferably, the internal gear pump comprises an internal gearwheel with an internally toothed ring, and an external gearwheel with an externally toothed ring, wherein the teeth of the internally toothed ring mesh together with the teeth of the externally toothed ring, and the working space is formed between the internal gearwheel and the external gearwheel.

In an additional embodiment, the internal gearwheel is mounted eccentrically with respect to the external gearwheel.

The rotary piston pump is expediently a rotating piston pump.

Expediently, the rotary piston pump with a, preferably integrated, electric motor comprises a, preferably electronic, control unit for controlling the energizing of the solenoids, and/or the electric motor is a brushless or an electronically commutated electric motor.

### BRIEF DESCRIPTION OF THE DRAWINGS

Exemplary embodiments of the invention are described in more detail below with reference to the attached drawings, in which:

FIG. 1 shows a cross section of a high pressure pump for conveying a fluid,

FIG. 2 shows a section A-A according to FIG. 1 of a roller with a roller shoe and a drive shaft,

FIG. 3 shows a highly schematized view of a high pressure injection system,

FIG. 4 shows a greatly simplified cross section of the high pressure pump with a pre-feed pump,

FIG. 5 shows a perspective view of a pre-feed pump without a housing, and of a stator,

FIG. 6 shows an exploded illustration of the pre-feed pump according to FIG. 5 with the housing,

FIG. 7 shows a cross section of an internal gearwheel and external gearwheel of the pre-feed pump according to FIG. 5, and

FIG. 8 shows a highly simplified cross section of the pre-feed pump.

### DETAILED DESCRIPTION

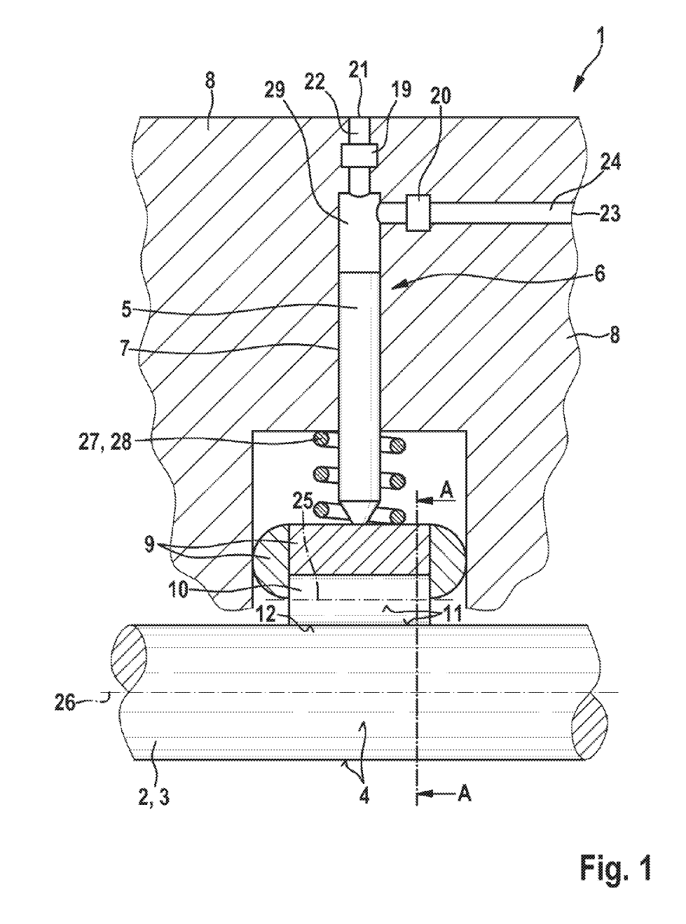

FIG. 1 illustrates a cross section of a high pressure pump 1 for conveying fuel. The high pressure pump 1 serves to convey fuel, for example gasoline or diesel, under high pressure to an internal combustion engine 39 for a motor vehicle. The pressure which can be maximally generated by the high pressure pump 1 lies, for example, within a range of between 1000 and 3000 bar.

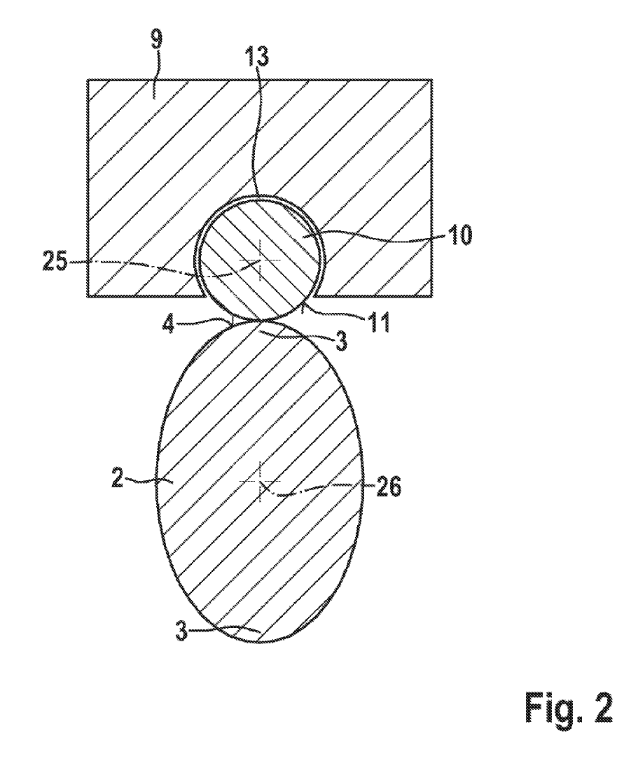

The high pressure pump 1 has a drive shaft 2 with two cams 3 which carry out a rotational movement about an axis of rotation 26. The axis of rotation 26 lies in the plane of the drawing of FIG. 1 and is perpendicular to the plane of the drawing of FIG. 2. A piston 5 is mounted in a cylinder 6 as a piston guide 7, the cylinder being formed by a high pressure pump housing 8 of the high pressure pump 1. A high pressure working space 29 is bounded by the cylinder 6 as the piston guide 7, and by the high pressure pump housing 8 and the piston 5. An inlet channel 22 with an inlet valve 19 and an outlet channel 24 with an outlet valve 20 open into the high pressure working space 29. The fuel flows through the inlet channel 22 with an inlet opening 21 into the high pressure working space 29, and the fuel flows under high pressure through the outlet channel 24 with an outlet opening 23 out of the high pressure working space 29 again. The inlet valve 19, for example a nonreturn valve, is designed to the effect that only fuel can flow into the working space 29, and the outlet valve 20, for example a nonreturn valve, is designed to the effect that only fuel can flow out of the working space 29. The volume of the high pressure working space 29 is changed on account of an oscillating stroke movement of the piston 5. The piston 5 is indirectly supported on the drive shaft 2. A roller shoe 9 with a roller 10 is fastened to the end of the piston 5 or pump piston 5. The roller 10 can carry out a rotational movement here and the axis of rotation 25 of said roller lies in the plane of the drawing according to FIG. 1 and is perpendicular to the plane of the drawing of FIG. 2. The drive shaft 2 with at least two cams 3 has a shaft rolling surface 4, and the roller 10 has a roller rolling surface 11.

The roller rolling surface 11 of the roller 10 rolls on the shaft rolling surface 4 as the contact surface 12 of the drive shaft 2 with the two cams 3. The roller shoe 9 is mounted in a roller shoe mounting, as a plain bearing, that is formed by the high pressure pump housing 8. A spring 27 or spiral spring 27 as an elastic element 28 which is clamped between the high pressure pump housing 8 and the roller shoe 9 applies a compressive force to the roller shoe 9 such that the roller rolling surface 11 of the roller 10 is in continuous contact with the shaft roller surface 4 of the drive shaft 2. The roller shoe 9 and the piston 5 therefore jointly carry out an oscillating stroke movement. The roller 10 is mounted in the roller shoe 9 with a plain bearing 13.

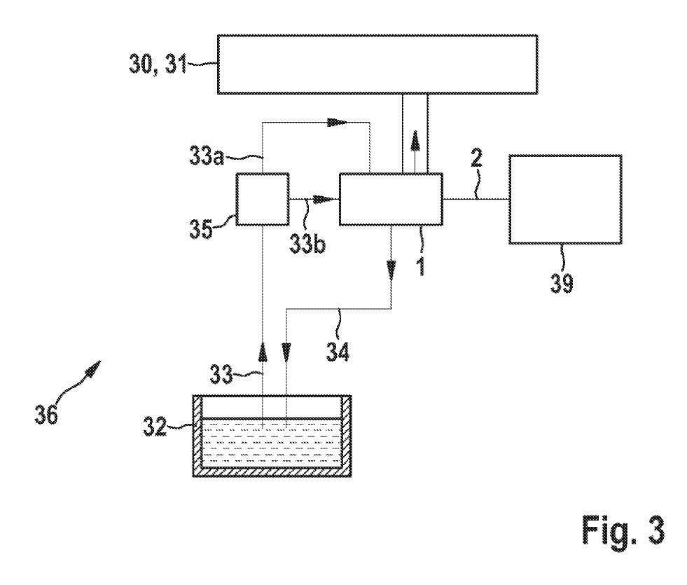

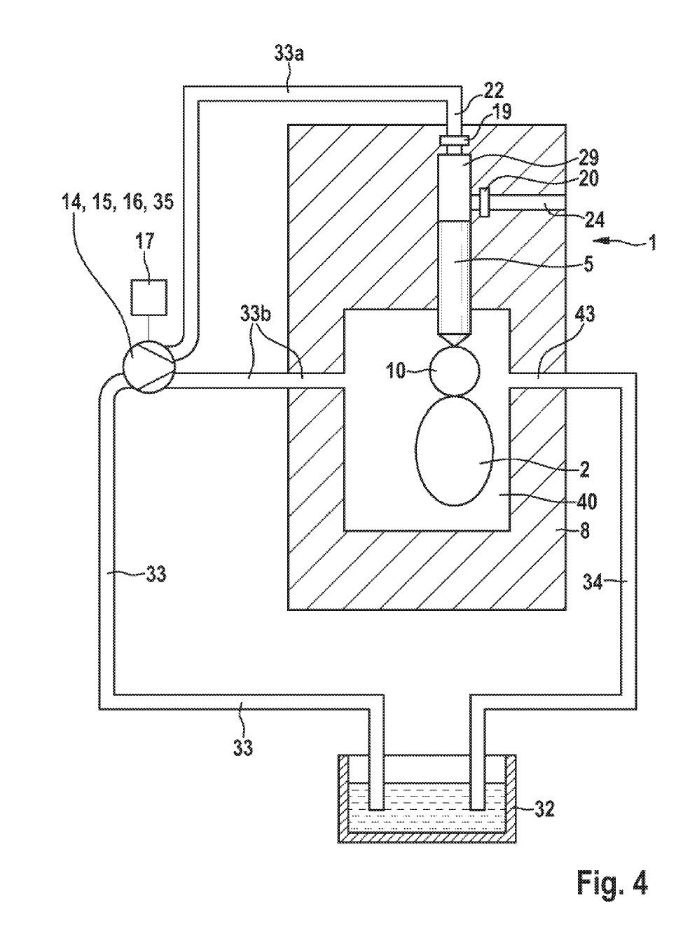

FIG. 3 depicts, in a highly schematized illustration, a high pressure injection system 36 for the motor vehicle (not illustrated), with a high pressure rail 30 or a fuel distributing pipe 31. From the high pressure rail 30 or a fuel distributing pipe 31, the fuel is injected by means of valves (not illustrated) into the combustion chamber of the internal combustion engine 39. An electric pre-feed pump 35 conveys fuel from a fuel tank 32 through a first fuel line 33a to the inlet channel 22 and through a second fuel line 33b to a lubricating space 40 (FIG. 4) of the high pressure pump 1. The high pressure pump 1 is driven here by the drive shaft 2, and the drive shaft 2 is a shaft, for example a crankshaft or cam shaft, of the internal combustion engine 39. The capacity of the electric pre-feed pump 35 can be controlled and/or regulated, and therefore, as a result, the quantity of fuel conveyed to the inlet channel 22 can be controlled and/or regulated. The high pressure rail 30 serves to inject the fuel into the combustion chamber of the internal combustion engine 39. The fuel not required by the high pressure pump 1 is conducted back again into the fuel tank 32 by an optional fuel return line 34.

FIG. 4 shows part of the high pressure injection system 36. The lubricating space 40 is formed within the high pressure pump housing 8 of the high pressure pump 1. The drive shaft 2, the roller 10 and the roller shoe 9 (not in FIG. 4) are depicted in the lubricating space 40 and the piston 5 is partially arranged therein. By means of the fuel conducted through the lubricating space 40, said components 2, 5, 9 and 10 are lubricated by the fuel. The fuel introduced by the second fuel line 33b into the lubricating space 40 is conducted out of the lubricating space 40 by the fuel return line 34 and supplied again to the fuel tank 32 (FIG. 4). FIG. 4 illustrates the high pressure injection system 36 illustrated in FIG. 3 in more detail without the high pressure rail 30 and without the internal combustion engine 39. The fuel sucked up from the fuel tank 32 by the pre-feed pump 35 is supplied by the pre-feed pump 35 at a pre-feed pressure, for example of 4 bar, by the first fuel line 33a to the inlet channel 22 of the high pressure pump 1. Furthermore, the fuel conveyed by the pre-feed pump 35 during operation of the internal combustion engine 39 is supplied by the second fuel line 33b to the lubricating space 40 for lubricating, for example, the drive shaft 2, the roller 10 and the piston 5. After the fuel flows through the lubricating space 40, the fuel is supplied again to the fuel tank 32 by the fuel return line 34. As a result, said components 2, 5, 9 and 10 can be lubricated and also cooled. In addition to the delivery of fuel for the high pressure pump 1, the pre-feed pump 35 also conveys an additional quantity of fuel for lubricating the high pressure pump 1, that is to say the fuel which flows through the lubricating space 40.

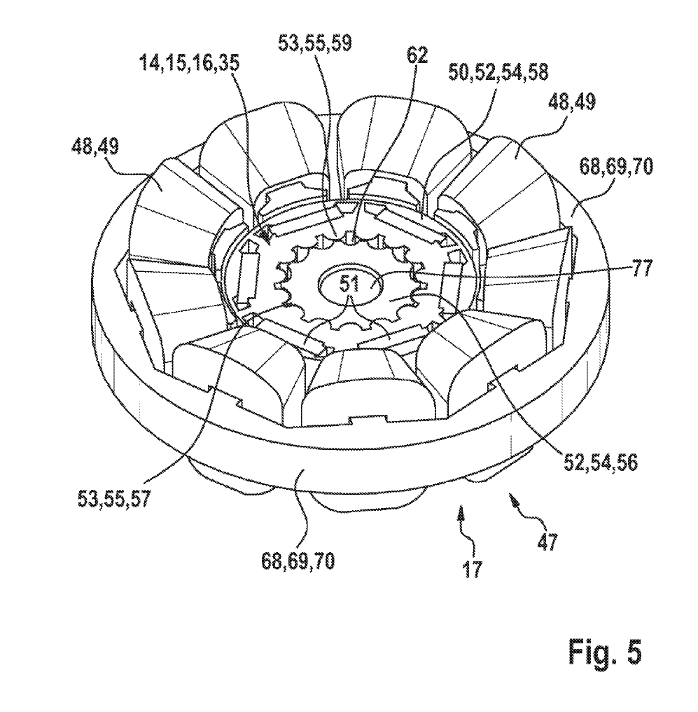

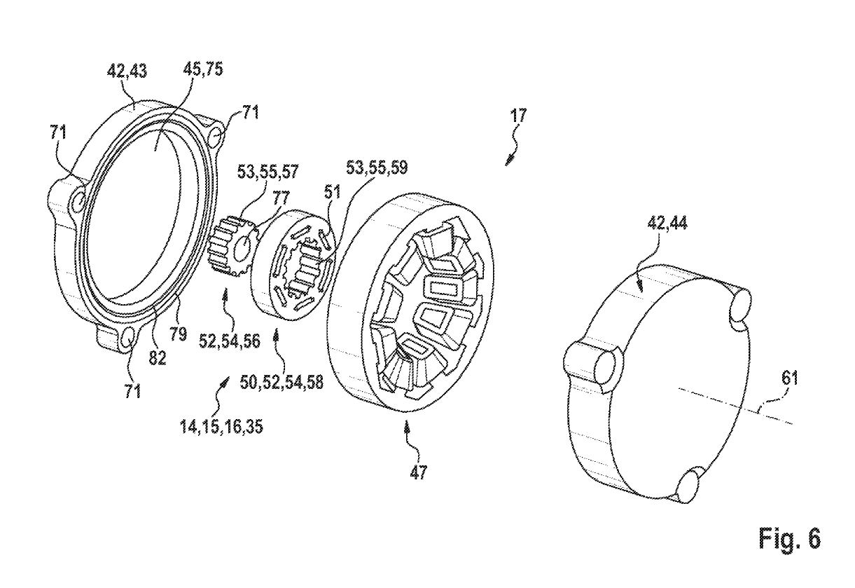

The electric pre-feed pump 35 has an electric motor 17 and a rotary piston pump 16, namely a gear pump 14, that is to say an internal gear pump 15 or gerotor pump 15 (FIGS. 5 to 8). The electric motor 17 of the gerotor pump 15 is integrated here in the gerotor pump 15. The high pressure pump 1 conveys fuel under high pressure, for example a pressure of 1000, 3000 or 4000 bar, through a high pressure fuel line to a high pressure rail 31. From the high pressure rail 31, the fuel is supplied under high pressure by an injector to a combustion chamber (not illustrated) of the internal combustion engine 39. The electric motor 17 (FIGS. 5 and 6) of the electric pre-feed pump 35 is operated with three-phase current or alternating current and can be controlled and/or regulated in power and therefore also in rotational speed. The three-phase current or alternating current for the electric motor 17 is provided by power electronics (not illustrated) from a direct voltage network of an electrical supply system of a motor vehicle (not illustrated). The electric pre-feed pump 35 is therefore an electronically commutated pre-feed pump 35.

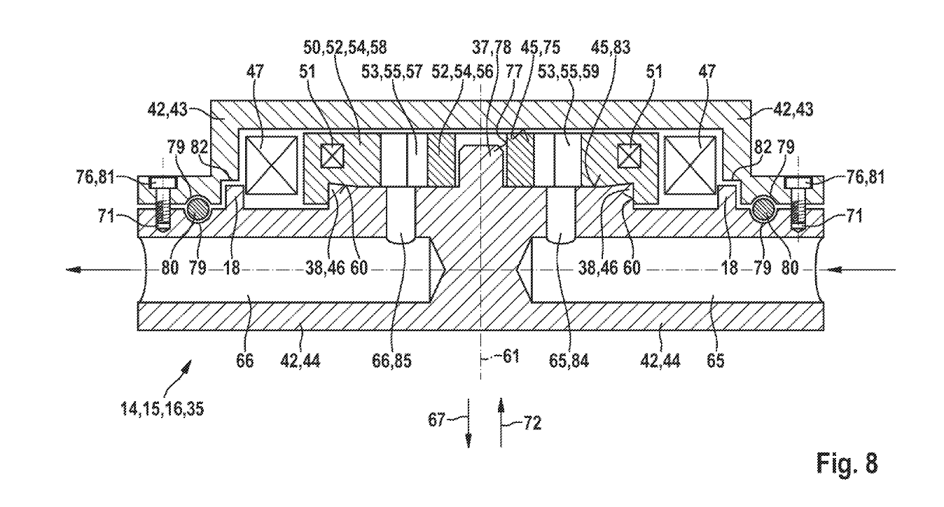

The electric pre-feed pump 35 or gerotor pump 15 has a housing 42 as the rotary piston pump housing 42 with a plate-like first housing part 44 and a pot-shaped second housing part 43 (FIGS. 6 and 8). Arranged within the housing 42 of the pre-feed pump 35 are the gerotor pump 15 as the internal gear pump 15 or gear pump 14 and the electric motor 17. The electric motor 17 has a stator 47 with windings 48 as solenoids 49 and a soft iron core 70 as a soft magnetic core 68 which is designed as a laminated core 69. The gerotor pump 15 as an internal gear pump 15 with an internal gearwheel 56 with an internally toothed ring 57 and an external gearwheel 58 with an externally toothed ring 59 is positioned within the stator 47. The internal and external gearwheel 56, 58 therefore constitute a gearwheel 54 and an impeller 52, and the internal and external toothed rings 57, 59 have teeth 55 as conveying elements 53. A working space 62 is formed between the internal and external gearwheels 56, 58. Permanent magnets 51 are fitted into the external gearwheel 58, and therefore the external gearwheel 58 also forms a rotor 50 of the electric motor 17. The electric motor 17 is therefore integrated in the gerotor pump 15, or vice-versa. The solenoids 49 of the stator 47 are energized in an alternating manner, and therefore the rotor 50 or the external gearwheel 58 is set into a rotational movement about an axis of rotation 61 because of the magnetic field arising at the solenoids 49.

The second housing part 43 and the first housing part 44 serve as an axial bearing 45 or plain bearing 45 for the internal or external gearwheel 56, 58. In addition, the first housing part 44 and the second housing part 43 each have three bores 71 in which screws (not illustrated in FIG. 6) for screw connections 81 are positioned as fastening elements 76 for screwing together the first housing part 44 and the second housing part 43, wherein the first housing part 44 and the second housing part 43 lie on each other in a fluidtight manner under prestress by means of a seal 80 (not illustrated in FIG. 6) in order to seal the working space 62.

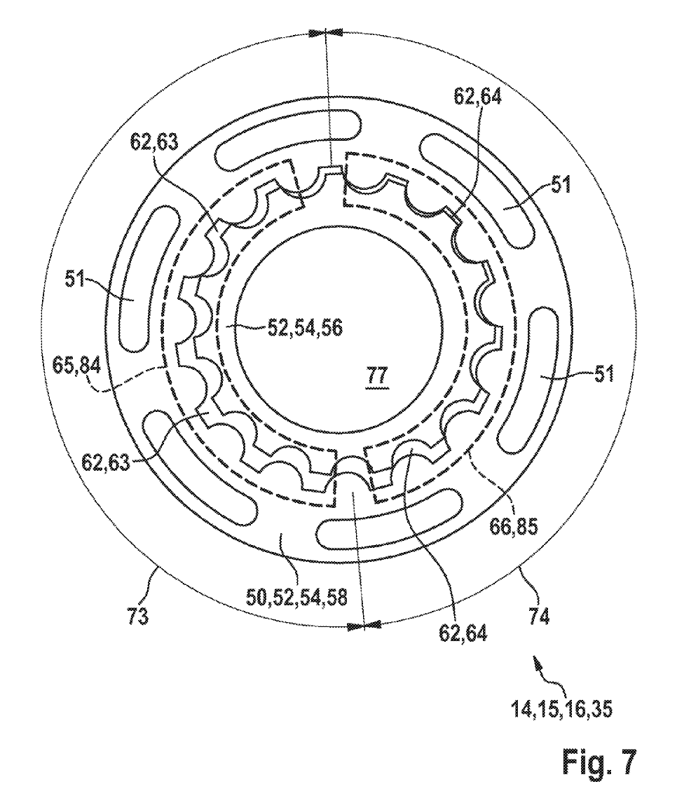

FIG. 7 illustrates the cross section of the internal gearwheel 56 and of the external gearwheel 58 of the gerotor pump 15. The working space 62 of the internal gear pump 15 is formed between the internal gearwheel 56 and the external gearwheel 58. If the internal and external gearwheels 56, 58 are rotated counterclockwise, with the internal and external gearwheels 56, 58 being mounted eccentrically with respect to each other, the working space 62 is formed at the internal and external gearwheels 56, 58, that is to say between the internal and external gearwheels 56, 58. An inflow working space 63 at which the working space 62 is enlarged and, as a result, an intake side of the internal gear pump 15 is present, is formed here at an angular region 73 of 180°. The outflow working space 64 at which the working space 62 is reduced and, as a result, a delivery side of the internal gear pump 15 arises, arises at an angular region 74 of the working space 62. An inflow channel 65 in the form of a kidney-shaped intake port 84 and which is formed on the housing 42 of the internal gear pump 15 opens into the inflow working space 63. The kidney-shaped intake port 84 here has an angular region of less than 180°. An outflow channel 66 in the form of a kidney-shaped delivery port 85 opens into the outflow working space 64. The inflow channel 65 in the form of the kidney-shaped intake port 84 and the outflow channel 66 in the form of the kidney-shaped delivery port 85 are each illustrated by dashed lines in FIG. 7. The fuel conducted through the outflow channel 66 is supplied by the first fuel line 33a to the inlet valve 19 of the high pressure pump 1 and is supplied by the second fuel line 33b to the lubricating space 40 (FIG. 4).

A cross section of the internal gear pump 15 or gerotor pump 15 is illustrated in FIG. 8. The inflow channel 65 and the outflow channel 66 are formed on the first housing part 44 which is of substantially plate-like design. An end region of the inflow channel 65 forms a kidney-shaped opening in the form of a kidney-shaped intake port 84 into the inflow working space 63 and an end of the outflow channel 66 opens in the form of a kidney-shaped delivery port 85 into the outflow working space 64. Screws are arranged in the bores 71, and therefore the pot-shaped second housing part 43 is thereby releasably connected to the first housing part 44, that is to say screw connections 81 are formed between the first and second housing part 44, 43. The two housing parts 43, 44 bound the working space 62 within which the internal gearwheel 56 and the external gearwheel 58 are arranged. The axis of rotation 61 of the internal gearwheel 56 is illustrated, but the axis of rotation of the external gearwheel 58 is not illustrated, and the axis of rotation of the external gearwheel 58 is oriented parallel to and at a distance from the axis of rotation 61 of the internal gearwheel 56, that is to say the internal and external gearwheels 56, 58 are oriented eccentrically with respect to each other.

The internal and external gearwheels 56, 58 are mounted on the two housing parts 43, 44 by means of a plain bearing. In the axial direction, that is to say in the direction of the axis of rotation 61, the internal and external gearwheel 56, 58 is slidingly mounted in a first axial direction 67 on a first axial plain bearing surface 83 of the first housing part 44. In a second axial direction 72 which is oriented perpendicularly to the first axial direction 67, the impellers 52 are mounted in the form of the internal and external gearwheel 56, 58 on a second axial plain bearing surface 75 on the second housing part 43. The first axial plain bearing surface 83 and the second axial plain bearing surface 75 therefore form an axial plain bearing 45. The radial orientation of the internal gearwheel 56 and of the external gearwheel 58 with respect to each other, that is to say the distance between the axis of rotation 61 of the internal gearwheel 56 and the axis of rotation of the external gearwheel 58 in the form of the eccentricity between the internal and external gearwheel 56, 58 is determined by a first radial bearing geometry 37 and a second radial bearing geometry 38. The first radial bearing geometry 37 is designed as a bearing stub 78 on the first housing part 44, and the second radial bearing geometry 38 is designed as an annular bearing step 46 on the first housing part 44. The first radial bearing geometry 37 and the second radial bearing geometry 38 are formed integrally with the rest of the first housing part 44. The bearing stub 78 is arranged within a bearing bore 77 on the internal gearwheel 56. The bearing bore 77 is designed as any desired cutout, for example in the form of a blind hole or through hole. An annular bearing recess 60 is formed on the external gearwheel 56, and, in the region of the annular bearing recess 60, the external gearwheel 58 rests on the second radial bearing geometry 38 in the form of the bearing step 46. With the two radial bearing geometries 37, 38, the internal and external gearwheels 56, 58 are therefore mounted radially in the radial direction perpendicular to the axis of rotation 61.

In addition, a centering geometry 18 is formed on the first housing part 44 and a mating centering geometry 82 is formed on the second housing part 43. The centering geometry 18 is designed as a ring formed integrally with the first housing part 44, and the mating centering geometry 82 is designed as an annular cutout on the second housing part 43. By means of the centering geometry 18, the second housing part 43 is oriented in the radial direction with respect to the first housing part 44, or vice-versa. A sealing groove 79 is formed in each case on the first and/or second housing part 43, 44, and the seal 80 is arranged within the sealing groove 79. Owing to the prestressing force acting between the first and second housing part 43, 44 from the screw connection 81, the working space 62 is thereby sealed in a fluidtight manner by the prestressed seal 80.

All of the radial bearing geometries 37, 38 and preferably the centering geometry 18 are formed on one side of the plate-like first housing part 44. During the production of the first housing part 44, an unprocessed component for producing the first housing part 44 has a corresponding geometry, and therefore subsequently, after clamping and fastening to a machining machine for processing by cutting, the first and second radial bearing geometry 37, 38 and the centering geometry 18 can be produced by cutting, for example by means of drilling and/or milling, without changing the clamping or fastening to the machining machine. The alignment of the first and second radial bearing geometry 37, 38 and of the centering geometry 18 with respect to one another can thereby be produced with a particularly high degree of manufacturing accuracy. The housing 42 and the internal and external gearwheels 56, 58 are produced from the same material, for example steel or aluminum. The rotary piston pump 16 thereby has an identical coefficient of thermal expansion, and therefore, even in the event of a change in temperature, the eccentricity between the internal and external gearwheels 56, 58 is substantially constant. When the housing 48 is formed from a material which is not suitable for a plain bearing of the impellers 52, that region of the housing 52 at the working space 62 which is intended for the radial and/or axial plain bearing of the impellers 52 can be provided with a corresponding coating or plating, for example of brass or a plastic suitable for the plain bearing, for example PTFE.

Considered overall, substantial advantages are associated with the rotary piston pump 16 according to the invention and the high pressure injection system 36 according to the invention. All of the radial bearing geometries 37, 38 for the radial alignment of the impellers 52 with respect to each other are formed on only one housing part 44, namely the first housing part 44. As a result, the impellers 52 can be aligned in the radial direction with respect to each other with a particularly high degree of accuracy, and therefore the rotary piston pump 16 thereby advantageously has high hydraulic efficiency and operates with little mechanical wear.

1. A rotary piston pump (16) for conveying a fluid, the rotary piston pump comprising
at least two impellers (52) with conveying elements (53) by which a rotational movement about a respective axis of rotation (61) can be carried out,
a working space (62) present at the at least two impellers (52), and
a multipart housing (42) with a first housing part (44) and a second housing part (43), wherein
at least two radial bearing geometries (37, 38) for the radial plain bearing of the at least two impellers (52) are formed on the housing (42),
characterized in that
the at least two radial bearing geometries (37, 38) are formed on only one housing part (44).

2. The rotary piston pump as claimed in claim 1, characterized in that all of the radial bearing geometries (37, 38) for all of the impellers (52) are formed on only one housing part (44), and/or the working space (62) is divided into an inflow working space (63) and into an outflow working space (64).

3. The rotary piston pump as claimed in claim 1, characterized in that a centering geometry (18) for the radial centering of another housing part (43) is formed on the housing part (44) with the at least two radial bearing geometries (37, 38).

4. The rotary piston pump as claimed in claim 1, characterized in that the at least two impellers (52) are mounted in the axial direction in a first axial direction (67) on the first housing part (44) and are mounted in the axial direction in a second axial direction (72) on the second housing part (43).

5. The rotary piston pump as claimed in claim 2, characterized in that the rotary piston pump (16) comprises an inflow channel (65) opening into the inflow working space (63) for introducing the fluid to be conveyed into the inflow working space (63) and an outflow channel (66) opening into the outflow working space (64) for draining the fluid to be conveyed from the outflow working space (64).

6. The rotary piston pump as claimed in claim 5, characterized in that the inflow channel (65) and/or the outflow channel (66) are/is formed on the housing part (44) with the at least two radial bearing geometries (37, 38).

7. The rotary piston pump as claimed in one or more of the preceding claim 1, characterized in that a first radial bearing geometry (37) is designed as a bearing stub (78), and the bearing stub (78) is arranged within a bearing bore (77) of a first impeller (52, 56), or vice-versa, such that the first impeller (52, 56) is mounted radially by means of the bearing stub (78).

8. The rotary piston pump as claimed in claim 1, characterized in that a second radial bearing geometry (38) is designed as a bearing step (46) which is at least partially, of annular design, and the bearing step (46) rests on a complementarily designed bearing recess (60) of a second impeller (52, 58), or vice-versa, such that the second impeller (52, 58) is mounted radially by means of the bearing step (46).

9. The rotary piston pump as claimed in claim 1, characterized in that the conveying elements (53) are teeth (55) of a gearwheel (54), and/or the rotary piston pump (16) is a gear pump (14).

10. The rotary piston pump as claimed in claim 1, characterized in that the rotary piston pump (16) comprises an electric motor (17) and the electric motor (17) is integrated in the rotary piston pump (16), and/or the capacity of the rotary piston pump (16) can be controlled and/or regulated, and/or rotational speed of the electric motor (17) being able to be controlled and/or regulated.

11. The rotary piston pump as claimed in claim 7, characterized in that the internal gear pump (15) comprises an internal gearwheel (56) with the bearing bore (77) as the first impeller (52), and an external gearwheel (58) with the bearing recess (60) as the second impeller (52).

12. The rotary piston pump as claimed in claim 1, characterized in that the housing part (44) with the at least two radial bearing geometries (37, 38) as the first housing part (44) is of substantially plate-like design.

13. The rotary piston pump as claimed in claim 1, characterized in that the housing part (43) without the at least two radial bearing geometries (37, 38) as the second housing part (43) is of substantially pot-shaped design.

14. The rotary piston pump as claimed in claim 1, characterized in that the at least two housing parts (43, 44) and/or the at least two impellers (52) are formed from the same material, and/or the second housing part (43) is connected to the first housing part (44) with at least one fastening element (76), and/or a seal (80) for the fluidtight sealing of the working space (62) is arranged between the first and second housing part (43, 44).

15. A high pressure injection system (36) for an internal combustion engine (39), comprising
a high pressure pump (1),
a high pressure rail (30), and
a pre-feed pump (35) for conveying a fuel from a fuel tank (32) through a fuel line (33a) to the high pressure pump (1),
characterized in that the pre-feed pump is designed as claimed in claim 1.

16. The rotary piston pump as claimed in claim 1, characterized in that all of the radial bearing geometries (37, 38) are formed on only one side of the only one housing part (44).

17. The rotary piston pump as claimed in claim 1, characterized in that all of the radial bearing geometries (37, 38) and the centering geometry (18) are formed on only one side of the housing part (44).

18. The rotary piston pump as claimed in claim 1, characterized in that all of the impellers (52) are mounted in the axial direction in a first axial direction (67) on the first housing part (44) and are mounted in the axial direction in a second axial direction (72) on the second housing part (43).

19. The rotary piston pump as claimed in claim 5, characterized in that the inflow channel (65) and/or the outflow channel (66) are/is formed on the housing part (44) with all of the radial bearing geometries (37, 38).

20. The rotary piston pump as claimed in claim 1, characterized in that a second radial bearing geometry (38) is designed as a bearing step (46) which is completely of annular design, and the bearing step (46) rests on a complementarily designed bearing recess (60) of a second impeller (52, 58), or vice-versa, such that the second impeller (52, 58) is mounted radially by means of the bearing step (46).

21. The rotary piston pump as claimed in claim 1, characterized in that the conveying elements (53) are teeth (55) of a gearwheel (54), and/or the rotary piston pump (16) is a gerotor pump (15).

22. The rotary piston pump as claimed in claim 1, characterized in that the rotary piston pump (16) comprises an electric motor (17) and the electric motor (17) is integrated in the rotary piston pump (16) by a rotor (50) of the electric motor (17) forming an impeller (52), by permanent magnets (51) being fitted into the impeller (52), and/or the capacity of the rotary piston pump (16) can be controlled and/or regulated by the power and/or rotational speed of the electric motor (17) being able to be controlled and/or regulated.

23. The rotary piston pump as claimed in claim 1, characterized in that the housing part (44) with all of the radial bearing geometries (37, 38) as the first housing part (44) is of substantially plate-like design.

24. The rotary piston pump as claimed in claim 1, characterized in that all of the housing parts (43, 44), and/or all of the impellers (52), are formed from the same material, wherein the material is steel or aluminum, and/or the second housing part (43) is releasably connected to the first housing part (44) with a screw connection (81), and/or an O-ring seal (80), for the fluidtight sealing of the working space (62), is arranged between the first and second housing parts (43, 44).
